(19) United States
(12) Patent Application Publication
(10) Pub. No.: US 2026/0312085 A1
(43) Pub. Date: Oct. 8, 2026

(54) BIPOLAR PLATE

(71) Applicant: SCHAEFFLER TECHNOLOGIES AG & CO.KG, Herzogenaurach (DE)

(72) Inventor: Sebastian Zwahr, Obermichelbach (DE)

(73) Assignee: Schaeffler Technologies AG & Co. KG, Herzogenaurach (DE)

(21) Appl. No.: 19/484,362

(22) PCT Filed: May 2, 2024
(86) PCT No.: PCT/DE2024/100394

§ 371 Date: Nov. 14, 2025

(30) Foreign Application Priority Data
May 15, 2023 (DE) 10 2023 112 722.5
Apr. 30, 2024 (DE) 10 2024 112 071.1

(51) Int. Cl. H01M 8/0265

(52) U.S. Cl. CPC H01M 8/0265

(57) ABSTRACT

A bipolar plate, for an electrochemical system, having a rectangular basic shape is provided. The bipolar plate includes two operating media ports and one coolant port arranged next to one another on each of the plate narrow sides. The coolant port is located between the operating media ports and has a port longitudinal side aligned parallel to the plate narrow side. Each operating media port has a port longitudinal side aligned parallel to a plate longitudinal side. A rectangular active field is located between the three ports on one plate narrow side and the three ports on the opposite plate narrow side. The active field has two active-field longitudinal sides. The active field includes linear channels for directing the flow of the operating media and the coolant parallel to the active-field longitudinal sides.

### CROSS-REFERENCE TO RELATED APPLICATIONS

This application is the United States National Phase of International Application PCT/DE2020/100394, filed May 2, 2024, which claims priority to German Application 10 2024 112 071.1 filed May 15, 2023 and German Application 10 2023 112 722.5, filed May 15, 2023. The disclosures of the above applications are incorporated herein by reference.

### TECHNICAL FIELD

The disclosure relates to a bipolar plate used in an electrochemical system and through which a coolant can flow.

### BACKGROUND

A bipolar plate is known, for example, from WO 2022/253384 A1. The known bipolar plate is made up of two rectangular half-sheets, on the narrow side of which three ports are arranged next to one another. These are two ports intended for the passage of operating media and a port which is arranged between the ports and which is intended for the passage of a coolant.

WO 2006/054399 A1 describes another bipolar plate having a rectangular basic shape, on each of the narrow sides of which three ports for different fluids are arranged. In this case, as in the case of WO 2022/253384 A1, the middle of the three adjacent ports is rectangular, where the two outer ports have a pentagonal cross-sectional shape.

Bipolar plates which are intended for use in fuel cell systems and through which ports with a triangular cross-sectional shape are provided are known, for example, from DE 10 2018 128 593 A1 and WO 2014/102534 A1.

A bipolar plate which is disclosed in DE 10 2008 056 900 A1 and which is also a component of a fuel cell has an arrangement of three ports, which in one case have a triangular shape, in one case a modified rectangular shape and in one case a pentagonal shape. The ports are not arranged in a row next to one another. Rather, the arrangement of the three ports describes an L-shape, with two ports located next to the narrow side of the bipolar plate, where the third port, separated from the narrow side by one of the first-mentioned two ports, is arranged next to a longitudinal side of the bipolar plate.

Various design options for bipolar plates forming ports with a circular cross-section are described in detail, for example, in DE 10 2021 212 053 A1 and DE 10 2021 207 304 A1.

### SUMMARY

One aspect of the disclosure provides a fuel cell for use in an electrochemical system, such as a fuel cell system that provides improvements to fluidic aspects and space utilization.

In some implementations, a bipolar plate includes a rectangular basic shape in a well-known basic concept, with three ports, namely two service ports and one cooling water port, being arranged next to one another on its narrow sides. The cooling water port is located between the two service ports. The cooling water port has a port longitudinal side which is oriented parallel to the plate narrow side, where each service port has a port longitudinal side which is oriented parallel to a plate longitudinal side. A rectangular active field is arranged between the three ports on one plate narrow side and the three ports on the opposite plate narrow side, with the active field having two active-field longitudinal sides, which are arranged parallel to the plate longitudinal sides. The active field has linear channels for directing the flow of the operating medium and for directing the flow of the coolant parallel to the longitudinal sides of the active field.

In some examples, the product of the length of the port longitudinal side of the coolant port and the length of the port longitudinal side of one of the two operating-means ports is at least six times, such as at least eight times, the product of the length of a port narrow side of the coolant port and the length of a port narrow side of the operating media port. The mentioned port narrow side of the operating media port is oriented parallel to the port longitudinal side of the coolant port. The one port longitudinal side of two operating media ports in each case is arranged in alignment and these are arranged in alignment with an active-field longitudinal side.

In some examples, when designing fluid-conducting contours in fuel cell stacks or stacks of other electrochemical cells, partly competing objectives must be considered. A design that is fluidically favorable can therefore require a lot of space. For example, if one considers only the flow resistance in a channel, a circular channel cross-section is considered optimal.

However, not only the flow of a gaseous or liquid fluid within the channel but also the forwarding of the fluid flowing out of the channel must be considered if, for example, this fluid is to be distributed as evenly as possible in a flat region, such as may be present in the form of an active field of an electrochemical cell, for example, a fuel cell. The same applies in cases where a fluid located in a flat region is to be collected and fed into a channel. Furthermore, it may be important whether the fluid is in liquid and/or gaseous form.

With regard to the flow of coolant through the active field or the linear channels in the active field, it is advantageous if the port is exactly as wide as the active field. In such an example, however, the operating media ports must be arranged 100% laterally next to the active field. In this case, space can be saved by approximating the cross-sections of the operating media ports to a circle, since this provides the largest area for a given size.

An active field through which the operating media and the coolant flow linearly is of great advantage in terms of the low pressure losses that occur. The flow paths of the operating media and the coolant are diverted at as few diversion points as possible in order to further minimize pressure losses.

Due to the very different properties of liquid media, such as coolants, on the one hand, and gaseous media, such as hydrogen and air or oxygen, on the other hand, media-specific characteristics must also be taken into account when designing fluid-conducting components. This concerns, for example, the design of a distributor field, which is placed between the arrangement of the various ports and the active field. In the distributor field, the various media must be distributed in the transverse direction of the bipolar plate, i.e., orthogonal to the main flow direction of the media. Since the transverse distribution of the gaseous operating media is easier than the transverse distribution of the liquid coolant, a longitudinal orientation of the operating media ports, in relation to the longitudinal direction of the bipolar plate which coincides with the main flow direction of the operating media, combined with a transverse orientation of the coolant port, appears to be sensible in principle. In principle, this approach is known from the prior art, including from the aforementioned documents WO 2022/253384 A1 and WO 2006/054399 A1.

The solution according to the disclosure goes beyond this approach by providing more extreme cross-sectional shapes of the ports that deviate more from a compact, for example, approximately square or circular, shape. Increased flow resistances are taken into account within the ports and a channel which is formed from the entirety of similar ports and runs through a cell stack comprising a large number of bipolar plates.

The fraction having a numerator given by the product of the length of the port longitudinal side of the coolant port and the length of the port longitudinal side of one of the two operating-means ports and having a denominator corresponding to the product of the length of a port narrow side of the coolant port and the length of a port narrow side of the operating-means port lies in the range between six and 30, such as in the range between eight and 18, according to various possible examples.

In some implementations, the length of the port longitudinal side of the coolant port, parallel to the plate narrow side of the entire bipolar plate, which length is to be measured in the transverse direction of the rectangular, non-square bipolar plate, corresponds to at least 40%, such as at least half, of the width of the bipolar plate. At the same time, the stated port longitudinal side extends, for example, over less than 80% of the length of the plate narrow side of the bipolar plate.

The coolant port can be centered between the two longitudinal sides of the bipolar plate. Alternatively, an eccentric arrangement of the coolant port can be considered. This is especially true in cases where the two adjoining operating media ports are of unequal size.

The pronouncedly elongated, not necessarily strictly rectangular cross-sectional shape of the coolant port compared to older solutions can be expressed, among other things, by the fact that the port longitudinal side of the coolant port oriented in the transverse direction of the bipolar plate is longer than the port longitudinal side of the operating media port oriented orthogonally to it and parallel to the longitudinal sides of the bipolar plate.

The rectangular shape or modified rectangular shape of the coolant port can be combined with a pentagonal cross-sectional shape of an operating-means port within the bipolar plate. In some examples, both operating media ports of the same triple port arrangement can be pentagonal. Optionally, the two operating media ports arranged next to the coolant port are designed to be mirror-symmetrical with respect to each other. The length of the port longitudinal sides of the operating media ports included in the stated quotient, which is in the range between 6 and 30, is to be measured on the side of the operating media port which has the shortest distance from the nearest longitudinal side of the bipolar plate.

In the case of an at least approximately rectangular cross-section of the coolant port, such as cooling water port, the ratio between the length of the port longitudinal side and the length of the port narrow side of the corresponding port can be more than three, such as in the range of four to ten.

The two port arrangements, each including three ports, can be formed mirror-imaged with respect to a plane located centrally between the two narrow sides of the bipolar plate.

In some implementations, the port longitudinal sides of two operating media ports are arranged in alignment with each other and in alignment with one of the active-field longitudinal sides. This has the advantage that the base area of the bipolar plate can be optimally utilized, which leads to material savings and a high power density per plate due to the arrangement of the active field and the ports on the plate.

It has proven advantageous if a distributor field is arranged between the port arrangements and the active field and if a plurality of mutually parallel channel portions, which are oriented in a flow direction extending along the plate longitudinal sides, are arranged between each cooling water port and the adjoining distributor field. In some examples, each distributor field fans out from the respective channel portions towards the active field.

In some implementations, the operating media ports are arranged on their side adjoining the respective distributor field (here the sloping side) so as to run parallel to the course of the distributor field.

Alternatively, the designs of the port arrangements located on both sides of the plane may differ from each other. For example, the cooling water port arranged first in the flow direction, i.e., on the inflow side, has a length/width ratio that is at least 50% greater than the cooling water port arranged subsequently in the flow direction, i.e., on the outflow side. The higher pressure of the cooling water on the inflow side allows the use of a particularly narrow, elongated port to supply the cooling water to the active field. The only small transverse components of the cooling water flow ensure uniform cooling across the entire width of the active field. At the outflow end of the coolant channels running through the bipolar plate, the coolant port which has a less extreme length/width ratio ensures that the coolant is discharged with low flow resistance.

The bipolar plate can be composed of two half-plates, such as half-sheets, using manufacturing technologies that are known in principle. In these cases, the coolant channels are formed between the half-plates. The electrochemical system, which includes a plurality of bipolar plates of the type according to the application, is, for example, a stationary or mobile fuel cell system, a redox flow battery or an electrolyzer for hydrogen production.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a bipolar plate intended for use in an electrochemical system, namely a fuel cell system,

FIG. 2 shows a non-claimed comparative example in a view analogous to FIG. 1.

Like reference symbols in the various drawings indicate like elements.

### DETAILED DESCRIPTION

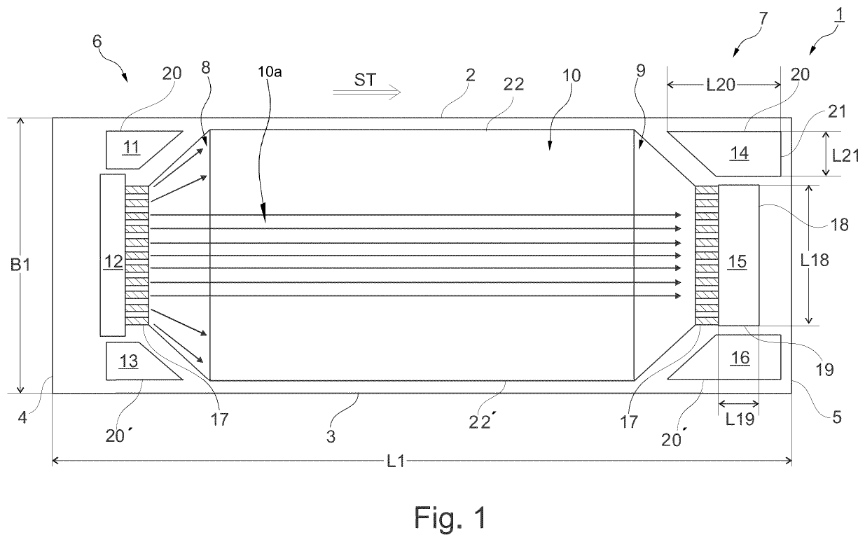

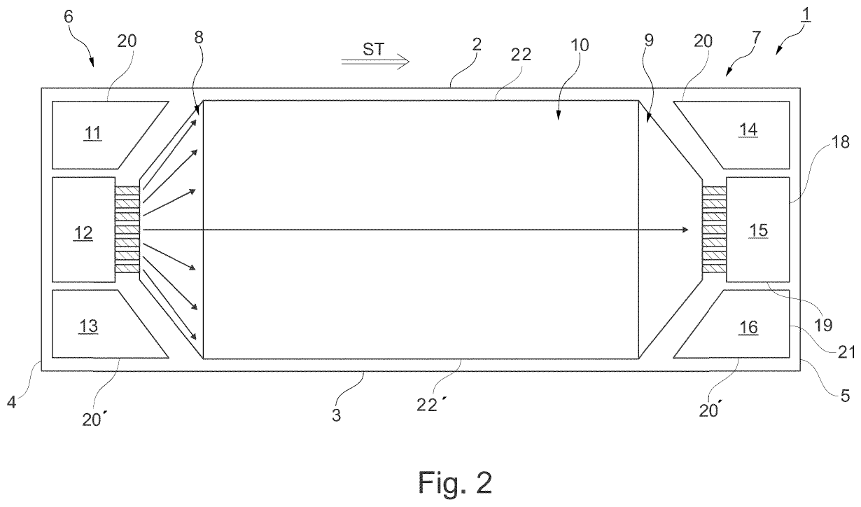

In the following text, the same reference signs are used, where applicable, both for the exemplary embodiment according to FIG. 1 and for the comparative example according to FIG. 2, which serves only for explanation.

A bipolar plate, denoted overall by reference sign 1, is used in a stack of electrochemical cells, namely fuel cells, and delimits a half-cell of a first electrochemical cell from a half-cell of another electrochemical cell. With regard to the basic function of the electrochemical system, which includes a plurality of bipolar plates 1 arranged in a stack, reference is made to the prior art cited at the outset.

The bipolar plate 1 is constructed in a manner known in principle from two half-plates between which a coolant flows. In this case, the half-plates are made of sheet metal, i.e., they are designed as half-sheets. Alternatively, the half-plates can be manufactured from an electrically conductive composite material containing graphite and bonded by a polymer.

The operating media flow on the outer surfaces of the bipolar plates 1 in a cell stack, also referred to as a stack for short. A rectangular active field denoted by 10, in which the desired electrochemical reactions take place, occupies most of the area of the bipolar plate 1.

The bipolar plate 1 has an elongated rectangular shape, with the longitudinal sides denoted by 2, 3 and the narrow sides denoted by 4, 5. The length of bipolar plate 1 is denoted by L1, the much smaller width of the bipolar plate is denoted by B1. Next to the first narrow side 4 there is a first port arrangement 6, and next to the second narrow side 5 there is a second port arrangement 7. The first port arrangement 6, which is arranged on the left in the arrangements according to FIGS. 1 and 2, includes three ports 11, 12, 13 arranged next to one another, namely two operating medium ports 11, 13 for the passage of operating medium of the electrochemical system, as well as a cooling water port 12, generally referred to as a coolant port, for supplying cooling water to the bipolar plate 1.

The cooling water flows through the bipolar plate 1 in the flow direction ST, i.e., substantially in the longitudinal direction of the bipolar plate 1, from left to right in the cases outlined. This does not imply any statement about the actual orientation of the bipolar plates 1. For example, the bipolar plates 1 can be oriented vertically within a cell stack.

On the second narrow side 5 there are three further ports 14, 15, 16 belonging to the second port arrangement 7. In this case, operating media, such as hydrogen and atmospheric oxygen, are directed through the two outer ports 14, 16, i.e., those arranged next to the two longitudinal sides 2, 3, while cooling water is discharged from the bipolar plate 1 through the middle port 15. All ports 11, 12, 13, 14, 15, 16 run through the fuel cell stack in the stacking direction.

The rectangular active field 10 is arranged between the three ports 11, 12, 13 on the plate narrow side 4 and the three ports 14, 15, 16 on the opposite plate narrow side 5, with the active field 10 having two active-field longitudinal sides 22, 22′, which as shown, are arranged parallel to the plate longitudinal sides 2, 3. The active field 10 has linear channels 10a for directing the flow of the operating media, i.e., hydrogen and oxygen, and for directing the flow of the coolant, i.e., the cooling water, parallel to the active-field longitudinal sides 22, 22′.

In some examples, a bipolar plate 1 made of two interconnected, three-dimensionally embossed thin half-sheets, the linear channels 10a in the active field 10 are formed through each half-sheet and are thus present on one side of a half-sheet in a positive form and on the rear side of the half-sheet in an inverse negative form.

Between the port arrangements 6, 7 and the active field 10 there is a distributor field 8, 9 in which the different material flows cross, based on the plan view according to FIGS. 1 and 2, and the different materials remain separated from each other. Between the cooling water ports 12, 15 and the distributor fields 8, 9, a plurality of channel portions 17 can be seen that are parallel to one another and oriented in the flow direction ST.

The extent of the flat region in which the short channel portions 17 are located already shows a clear difference between FIG. 1 and FIG. 2:

As shown in FIG. 1, cooling water, which is supplied to the distributor field 8 through the channel portions 17, flows to a large extent in a straight direction, namely in the longitudinal direction of the bipolar plate 1, through the distributor field 8 to the active field 10. Only in relatively narrow edge regions of the distributor field 8 does the cooling water flow need to be significantly fanned out in order to reach the active field 10 over its entire width. Comparable conditions exist in the region of the second distributor field 7 and the second port arrangement 7, i.e., on the outflow side of the cooling water, in which, in this case, the cooling water flow is to be consolidated.

As shown in FIG. 1, in the non-claimed comparative example according to FIG. 2 there is a much more pronounced fanning out of the cooling water flow in the first distributor field 7 and a likewise much more pronounced constriction of the cooling water flow in the second distributor field 8. This results in a significantly higher flow resistance in the case of FIG. 2. A continuous straight flow through the bipolar plate 1 occurs only in a central, very narrow region, as indicated in FIG. 2 in an idealized manner by a single long arrow oriented in the flow direction ST.

The largely straight, low-resistance flow through the bipolar plate 1 according to FIG. 1 is achieved primarily by the design of the port arrangements 6, 7. The cooling water ports 12, 15 each have an elongated rectangular shape, with a longitudinal side 18 of the relevant port 12, 15 being parallel next to the nearest plate narrow side 4, 5. The narrow sides of the cooling water port 12, 15 are denoted by 19. The port longitudinal side 18 of each cooling water port 12, 15 has a length L18 which is more than three times the length, denoted by L19, of the port narrow side 19 of the same cooling water port 12, 15.

In contrast to the cooling water ports 12, 15, the operating media ports 11, 13, 14, 16 each have a pentagonal cross-sectional shape. In this case, a longitudinal side 20, 20′, which represents the longest of the five sides of the operating media port 11, 13, 14, 16, is closest to the longitudinal side 2, 3 of the bipolar plate 1 adjacent to the relevant operating media port 11, 13, 14, 16. The longitudinal sides 20, 20′ of all operating media ports 11, 13, 14, 16 are thus oriented orthogonally to the longitudinal sides 18 of the cooling water ports 12, 15.

Parallel to the longitudinal sides 18 of the cooling water ports 11, 15 are the narrow sides, denoted by 21, of the operating media ports 11, 13, 14, 16. The narrow side 21 is the side of the operating media port 11, 13, 14, 16 which has the smallest distance from the adjacent narrow side 4, 5 of the bipolar plate 1. The length of each port narrow side 21 is denoted by L21.

The following relationship exists between the different lengths L18, L19, L20, L21 of the different ports 11, 12, 13, 14, 15, 16:

$$6 < ( L 18 \times L 20 ) / ( L 19 \times L 21 ) < 30$$

The fraction given in this relationship, i.e., the quotient of the product of the lengths L18, L20 of the two longitudinal sides 18, 20 and 20′ as the numerator and the product of the lengths L19, L21 of the two narrow sides 19, 21 as the denominator, is a dimensionless value, so the validity of the relation does not depend on the chosen units.

A number of implementations have been described. Nevertheless, it will be understood that various modifications may be made without departing from the spirit and scope of the disclosure. Accordingly, other implementations are within the scope of the following claims.

### REFERENCE NUMERALS

1 Bipolar plate
2 Longitudinal side of the bipolar plate, plate longitudinal side
3 Longitudinal side of the bipolar plate, plate longitudinal side
4 Narrow side of the bipolar plate, plate narrow side
5 Narrow side of the bipolar plate, plate narrow side
6 Port arrangement, inflow side of the cooling water
7 Port arrangement, outflow side of the cooling water
8 Distributor field
9 Distributor field
10 Active field
10a Linear channels
11 Operating-means port
12 Cooling water port
13 Operating-means port
14 Operating-means port
15 Cooling water port
16 Operating-means port
17 Channel portion
18 Longitudinal side of the cooling water port, port longitudinal side
19 Narrow side of the cooling water port, port narrow side
20, 20′ Longitudinal side of the operating-means port, port longitudinal side
21 Narrow side of the operating-means port, port narrow side
22, 22′ Active-field longitudinal side
B1 Width of the bipolar plate
L1 Length of the bipolar plate
L18 Length of the port longitudinal side of the cooling water port
L19 Length of the port narrow side of the cooling water port
L20 Length of the port longitudinal side of the operating-means port
L21 Length of the port narrow side of the operating-means port
ST Flow direction

1. A bipolar plate for an electrochemical system, having a rectangular basic shape, the bipolar plate comprising:
three ports positioned on a plate narrow side, the three ports include two operating media-means ports and one coolant port arranged next to one another, wherein the coolant port is positioned between the operating media ports and has a port longitudinal side oriented parallel to the plate narrow side, wherein each operating media port has a port longitudinal side oriented parallel to a plate longitudinal side,
a rectangular active field arranged between the three ports on a plate narrow side and the three ports on the opposite plate narrow side, wherein the rectangular active field includes:
two active-field longitudinal sides, each active-field longitudinal side arranged parallel to the plate longitudinal sides, and
linear channels for directing flow of the operating media and directing flow of the coolant parallel to the active-field longitudinal sides,
wherein a product of a length of the port longitudinal side of the coolant port and a length of the port longitudinal side of one of the two operating media ports adjacent to the coolant port is at least six times a product of a length of a port narrow side of the coolant port and a length of a port narrow side of the operating media port.

2. The bipolar plate according to of claim 1, wherein the port longitudinal sides of two operating-means ports are arranged in alignment and are arranged in alignment with one of the active-field longitudinal sides.

3. The bipolar plate of claim 1, wherein the product of the length of the port longitudinal side of the coolant port and the length of the port longitudinal side of one of the two operating media ports is not more than 30 times the product of the length of the port narrow side of the coolant port and the length of the port narrow side of the operating media port.

4. The bipolar plate of claim 3, wherein the relationships specified in claim 1 applies to both operating media ports adjacent to the coolant port.

5. The bipolar plate of claim 1, wherein the length of the port longitudinal side of the coolant port corresponds to at least half the width of the bipolar plate.

6. The bipolar plate of claim 1, wherein the port longitudinal side of the coolant port is longer than the port longitudinal side of the operating media port oriented orthogonal thereto.

7. The bipolar plate of claim 1, wherein at least one operating media port has a pentagonal cross-sectional shape.

8. The bipolar plate of claim 7, wherein each operating media port has a pentagonal cross-sectional shape.

9. The bipolar plate of claim 1, wherein a ratio between the length of the port longitudinal side of the coolant port and the length of the port narrow side of the coolant port is at least three.

10. The bipolar plate of claim 1, wherein port arrangements each comprise three ports and are formed mirror-imaged with respect to a plane which is located centrally between two narrow sides of the bipolar plate.

11. The bipolar plate of claim 10, wherein:
a first port arrangement comprises three ports arranged next to one another and adjacent to the first plate narrow side,
a second port arrangement comprises three ports arranged next to one another and is arranged on the second plate narrow side, the first port arrangement differs from the second port arrangement.

12. The bipolar plate of claim 10, further comprises:
a distributor field is arranged between each of the port arrangements and the active field, and
a plurality of channel portions arranged between each cooling water port and the adjoining distributor field, the channel portions are parallel to one another and oriented in a flow direction extending along the plate longitudinal sides.

13. The bipolar plate of claim 12, wherein each distributor field fans out from the respective channel portions in the direction of the active field.

14. The bipolar plate of claim 13, wherein the operating media ports are arranged on their side adjoining the respective distributor field so as to run parallel to a course of the distributor field.

15. The bipolar plate of claim 13, wherein the cooling water port arranged first in the flow direction has a length/width ratio that is at least 50% greater than the cooling water port arranged subsequently in the flow direction.
